(19) United States
(12) Patent Application Publication
(10) Pub. No.: US 2003/0027634 A1
(43) Pub. Date: Feb. 6, 2003

(54) Portable wireless game device and method for influencing an application executable from a fixed-location platform

(76) Inventor: William F. Matthews III, Phoenix, AZ (US)

Correspondence Address: Lowell W. Gresham, MESCHKOW & GRESHAM, P.L.C., Suite 409, 5727 North Seventh Street, Phoenix, AZ, 85014, US

(21) Appl. No.: 09/922,121

(22) Filed: Aug. 3, 2001

(51) Int. Cl. G06F 17/00

(52) U.S. Cl. 463/39

(57) ABSTRACT

A portable wireless transceiver device (22) is carried by an individual (24) during the normal course of daily activities. The device (22) receives and records load instructions (84) from other transmitter devices (22, 26) at difference locations and at different instants in time through the day. Later, the device (22) interfaces a fixed-location platform (58) and the load instructions (84) are downloaded from the device (22) to the platform (58). A game application (64), executable from the fixed-location platform (58), is updated in response to the downloaded load instructions (84) to affect an outcome of the game application (64).

### TECHNICAL FIELD OF THE INVENTION

The present invention relates to transmitting and receiving gaming information. More particularly, the present invention relates to the wireless transmission and receipt of gaming information for influencing a game application executable from a fixed-location platform.

### BACKGROUND OF THE INVENTION

The electronic entertainment and game industry is continually evolving in an attempt to satisfy consumers' thirst for technological gadgetry and more exciting game play. This evolution includes the introduction of better graphics, better sound, more colors, and more complex game scenarios which increase the realism of game play. A large variety of devices exist for playing electronic game applications. These devices include, for example, portable units and large, fixed-location game units, such as the personal computer (PC) and television console games.

Portable units are typically hand-held and self-contained. For example, some portable units arrive from the manufacturer programmed with a single game application. Although relatively inexpensive, these single game portable units quickly lose their appeal since only one game may ever be played on them. Other portable units can execute a number of game applications provided on separately purchased game cartridges. These portable units are more appealing than the single game units because of the great variety of game cartridges that are on the market. However, they have problems associated with the undesirably high purchase cost of the game cartridges, poor sound and graphics, and limited battery life. In addition, these portable units are often single player devices, and as such, do not promote social interaction between game players.

Game applications, such as personal computer (PC) games, Internet games, and electronic games that are played on the PC or on a television console system typically have better graphics, better sound, and more complex games scenarios than do the portable units. In addition, these game applications can be played by two or more co-located players, or by two or more remotely located players linked through network connections, thus promoting more social interaction than the portable units. In order to play these game applications, each user actively interacts with the game application running on the PC or television console system and makes decisions that affect the game state. Unfortunately, PCs and television consoles are not readily portable. Thus, the user must suspend the game application executing on a PC or on the television console when required to go to work, to school, or to take care of other obligations.

Designers have recently introduced hand-held electronic game units that may “play” an electronic game application with or without the user's knowledge while the user carries out their normal daily activities. These portable electronic game units utilize radio frequency (RF) wireless technology for transmitting and receiving game data between two or more units. When two or more of these wireless portable game units are within a transmission range of one another, game data may be exchanged that affects an outcome of a game application executed on the units. The user at a later point in time may view the results of the data exchange. While these devices provide a more portable game experience than PC and television console based game applications, the units can only execute one multiplayer game. Moreover, since the game application is executed on the hand-held electronic units, the realism and intricacy of the game play suffers due to limited graphics and sound capabilities, limited memory, and limited battery life.

### SUMMARY OF THE INVENTION

Accordingly, it is an advantage of the present invention that a portable, wireless game device and method are provided that extend entertainment or game activity beyond a conventional fixed-location platform.

It is another advantage of the present invention that the device and method allow a user to influence a game application executable from the fixed-location platform while being separated from the fixed-location platform.

Another advantage of the present invention is that the device interacts with another co-located portable, wireless game device without the user's attention or knowledge.

Yet another advantage of the present invention is that the device and method promote social interaction between game players through the exchange of game data and player identification information.

The above and other advantages of the present invention are carried out in one form by a method for influencing an application executable from a fixed-location platform. The method calls for receiving a load instruction at a portable wireless transceiver and recording the load instruction in a memory element of the portable wireless transceiver. The method further calls for interfacing the portable wireless transceiver with the fixed-location platform, downloading the load instruction from the portable wireless transceiver to the fixed-location platform, and updating, at the fixed-location platform, the application in response to the load instruction to affect an outcome of the application.

The above and other advantages of the present invention are carried out in another form by a portable wireless device for influencing an application executable from a fixed-location platform. The portable wireless device includes a transceiver for detecting load instructions transmitted from wireless transmitters at different instants in time and positioned at different locations. A processor, in communication with the transceiver, receives the load instructions and records each of the load instructions in a memory element in communication with the processor. An interface is in communication with the processor and is configured for coupling with the fixed-location platform so that the load instructions may be downloaded to the fixed-location platform, wherein at least one of the load instructions is operable to affect an outcome of the application.

### BRIEF DESCRIPTION OF THE DRAWINGS

A more complete understanding of the present invention may be derived by referring to the detailed description and claims when considered in connection with the FIGS., wherein like reference numbers refer to similar items throughout the FIGS., and:

FIG. 1 shows a block diagram of an environment in which a portable wireless device may be utilized in accordance with a preferred embodiment of the present invention;

FIG. 2 shows a block diagram of the portable wireless device of FIG. 1;

FIG. 3 shows a perspective view of the portable wireless device in an exemplary configuration;

FIG. 4 shows a block diagram of an environment in which the portable wireless device is in communication with a fixed-location platform;

FIG. 5 shows a flow chart of a mobile game play process performed by the portable wireless device;

FIG. 6 shows a table, stored in a memory element of the portable wireless device, of load instructions received by the portable wireless device and a transmission load instruction to be transmitted from the portable wireless device; and

FIG. 7 shows a flowchart of a game update process performed at the fixed-location platform.

### DETAILED DESCRIPTION OF THE PREFERRED EMBODIMENTS

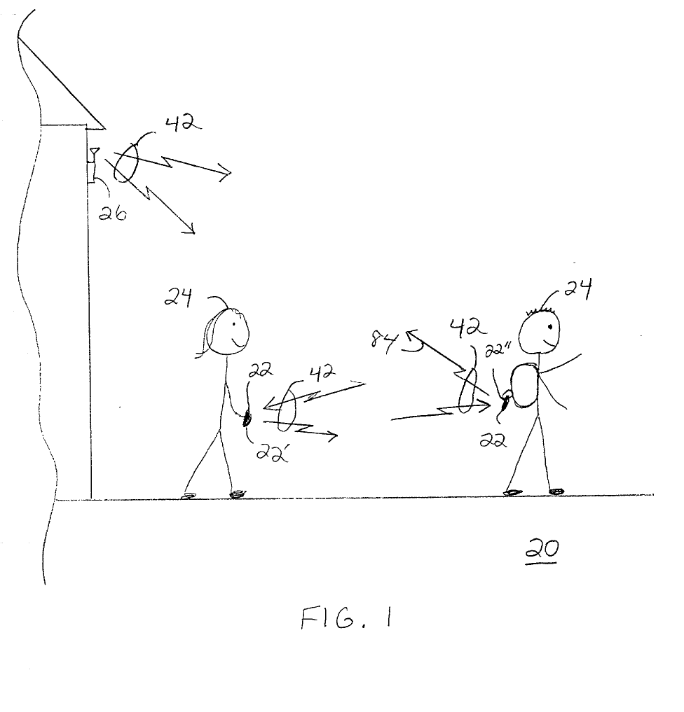

FIG. 1 shows a block diagram of an environment 20 in which a portable wireless transceiver device 22 may be utilized in accordance with a preferred embodiment of the present invention. Environment 20 includes individuals 24, each carrying portable wireless transceiver device 22. Individuals 24 may wear or carry device 22 as they attend to normal daily living and social functions. Portable wireless transceiver device 22 extends the boundaries of a PC-based or television console-based game application by allowing the behavior of the console-based game application to be influenced by the location of each portable wireless device 22 and the interaction of device 22 with other similar devices 22.

More particularly, each device 22 is capable of receiving and recording load instructions (discussed below) which may later be downloaded to a fixed-location platform (i.e., PC or television console system) to affect a game application (discussed below) executable from the fixed-location platform. The load instructions may be transmitted by another portable wireless transceiver device 22. Alternatively, the load instructions may be transmitted by a fixed-location transmitter 26 located in stores and other public places. Thus, the present invention provides an opportunity to continue playing a game application, executable from a fixed-location platform, when away from the platform, and provides for new activities to influence and enhance individuals' home-based game application.

Only two individuals 24 are shown, each carrying portable wireless device 22, for simplicity of illustration. However, any number of individuals 24 may have their own portable wireless device 22. Indeed, it will become readily apparent that a greater number of individuals with portable wireless devices 22 enhances game play.

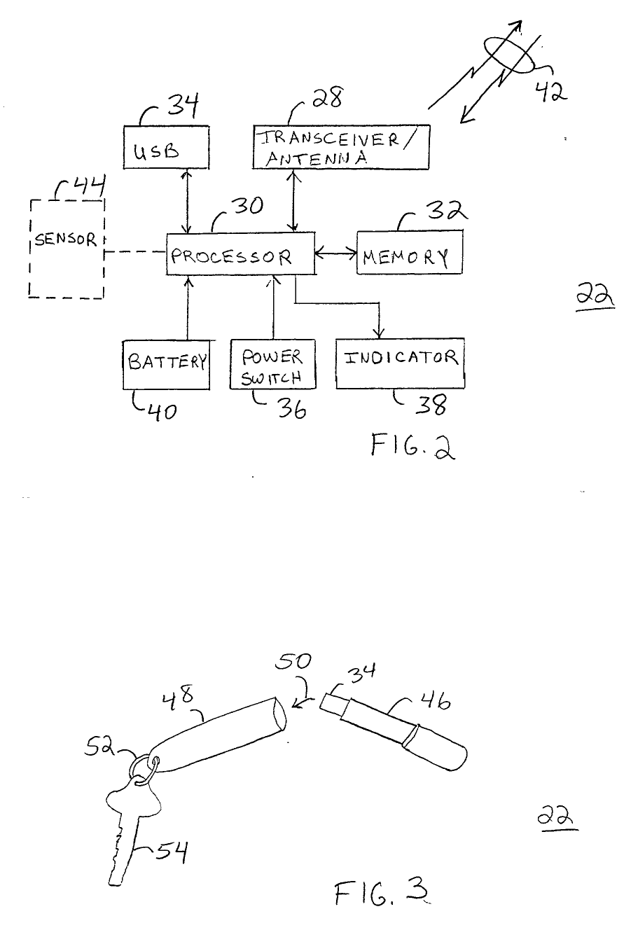

Referring to FIGS. 1 and 2, FIG. 2 shows a block diagram of portable wireless transceiver device 22. Device 22 includes a transceiver/antenna 28 and a processor 30, in communication with transceiver/antenna 28, on which the methods according to the invention can be practiced. Processor 30 is further in communication with each of a memory element 32, an interface 34, a power switch 36, and a status indicator 38. Power is provided to device 22 by means of a battery 40. The components of device 22 may be economically implemented utilizing known off-the-shelf components.

Transceiver/antenna 28 is operable for transmission and reception utilizing a license free frequency band 42, such as the North American 915 MHz Industrial, Scientific, and Medical (ISM) band and the European 433 MHz/868 MHz ISM band. Through the use of license free frequency band 42, no user license or airtime usage fees are required. Transceiver/antenna 28 desirably has a wireless range of approximately two hundred feet.

Memory element 32 is addressable storage space, accessible by processor 30, which stores information and instructions for use, and interface 34, in an exemplary embodiment, is universal serial bus (USB) port. In alternative embodiments, interface 34 may encompass a serial RS232 port, a telephone line interface, a wireless interface, using 802.11 or Bluetooth protocols, or an infrared transmission interface. Power switch 36 may be a user actuated toggle or pushbutton switch. In an exemplary embodiment, status indicator 38 is an light emitting diode (LED) for indicating a power “ON” status of device 22. However, in alternative embodiments, status indicator 38 may be a vibrator or a small liquid crystal display (LCD).

Battery 40 may be a conventional electrochemical cell and may be either a non-rechargeable battery or a rechargeable battery that can operate for approximately forty-eight hours on a single charge. Alternatively, device 22 may be powered by light (i.e., sunlight or room light). Processor 30 may optionally place device 22 in a sleep mode to preserve battery power, and wake from the sleep mode in response to motion, light, and so forth.

In another alternative embodiment, device 22 may be incorporated into another product or toy (for example, toy dolls, toy soldiers, stuffed animals, and so forth) to provide entertainment and add the capabilities of portable wireless transceiver device 22 to the other product. Accordingly, device 22 may be powered by the power source of the toy, for example, an electronic doll.

Portable wireless transceiver device may further include a sensor 44 in communication with processor 30. Sensor 44 is configured to produce a sensor signal responsive to a location of device 22 in environment 20. Sensor 44 may be a temperature sensor, humidity sensor, light sensor, motion sensor, audio level sensor, pedometer, global positioning system (GPS) receiver, and so forth known to those skilled in the art. The corresponding signal produced by such sensors can be utilized to influence a game application executable from a fixed-location platform (discussed below).

FIG. 3 shows a perspective view of portable wireless transceiver device 22 in an exemplary configuration. Device 22 is configured as a key chain ornament. A housing 46 encloses transceiver/antenna 28, processor 30 (FIG. 2), memory element 32, power switch 36, indicator 38, battery 40, and sensor 44. USB interface 34 is located at an end of housing 46. USB interface 34 is protected by a cover 48 which is slid over housing 46, as represented by an arrow 50, when device 22 is being used. Cover 48 includes a conventional key chain attachment ring 52 for the attachment of keys 54. Alternatively, ring 52 may be attached to a belt loop or attached to a backpack or purse.

FIG. 3 shows one exemplary configuration of portable wireless transceiver device 22. Alternatively, the color and shape of device 22 may be selected to appeal to the targeted market group. Thus, housing 46 may be formed from a semi-conforming gel or molded to comfortably fit in a child's hand. Housing 46 may also incorporate a small keypad and display.

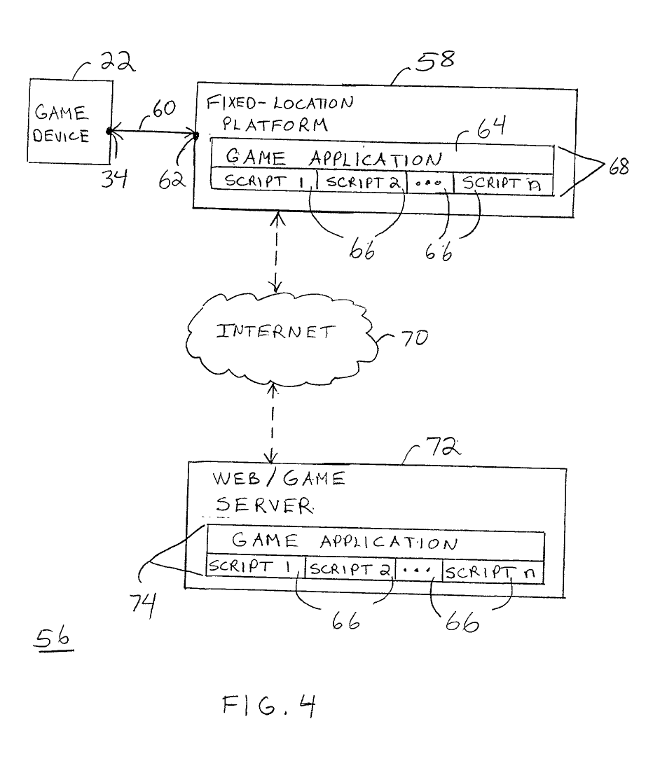

FIG. 4 shows a block diagram of an environment 56 in which portable wireless transceiver device 22 is in communication with a fixed-location platform 58. In particular, a cable 60 couples interface 34 with a USB port 62 on fixed-location platform 58. Environment 56 may be the home of an individual 24 (FIG. 1) so that fixed-location platform 58 is home based. Fixed-location platform 58 is a personal computer (PC) from which a game application 64 is played, or executed. In an alternative embodiment, fixed-location platform 58 is a television console unit on which game application 64 is played.

A number of scripts 66, stored in memory locations 68 of fixed-location platform 58, are associated with game application 64. Each of scripts 66 is a short program that consists of a sequence of instructions that may be interpreted and carried out by game application 64. In a preferred embodiment, specific ones of scripts 66 are selected for interpretation and execution by game application 64 in response to load instructions (discussed below) received by device 22 and downloaded to fixed-location platform 58. Thus, through the download and execution of load instructions, device 22 may influence the outcome of game application 64.

Scripts 66 may be provided with game application 64 by the developer of game application 64. Alternatively, scripts 66 may be provided by a software developer different from the developer of game application 64.

Game application 64 is a PC-based application played solely on platform 58. Alternatively, game application 64 may be an Internet-based game in which segments of the game application are located at fixed-location platform 58, while other segments of the game application are located within and executable from a remote web/game server 72 accessible via the Internet 70. Accordingly, memory locations 74 of remote server 72 may contain scripts 66 associated with the Internet-based game application.

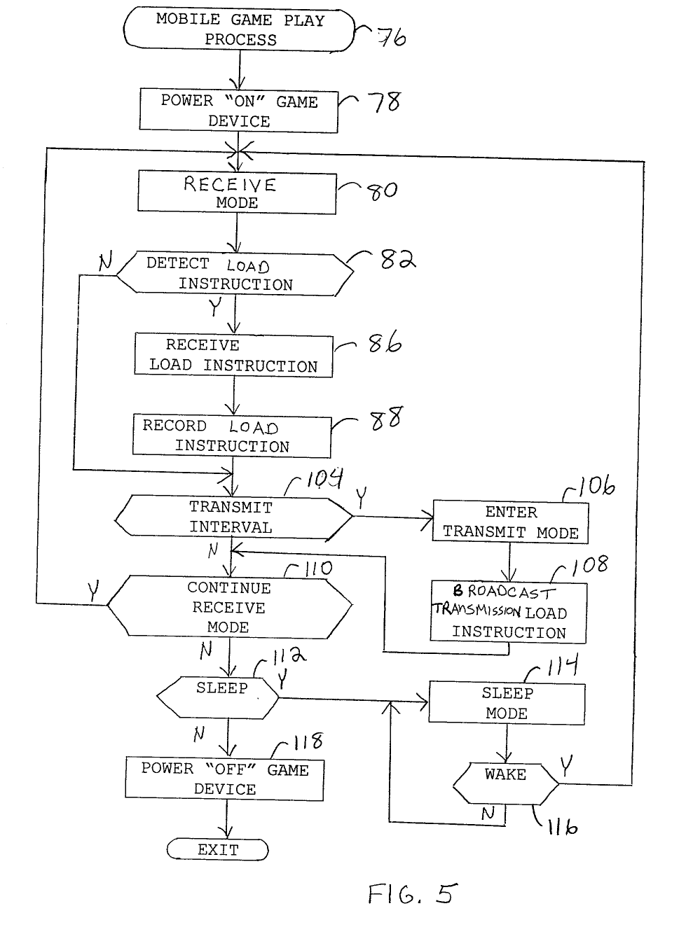

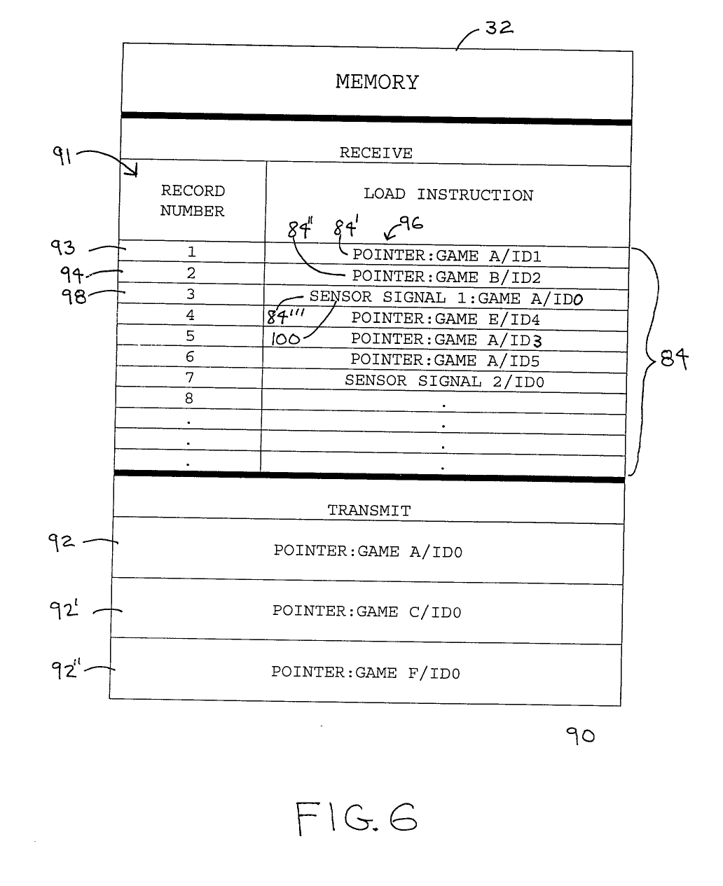

FIG. 5 shows a flow chart of a mobile game play process 76 performed by portable wireless transceiver devices 22. Process 76 may be carried out by each of devices 22 through the execution, by processor 30 (FIG. 2), of a set of instructions (not shown) stored in memory element 32 (FIG. 2) of each device 22. As mentioned previously, portable wireless transceiver device 22 extends the boundaries of game application 64 (FIG. 4) by allowing game behavior to be influenced by the location of portable wireless transceiver device 22 and the interaction of device 22 with other devices 22 and fixed-location transmitter 26 (FIG. 1).

For clarity of illustration, process 76 is executed by a first portable wireless transceiver device 22′ (FIG. 1). However, it should be understood that a second portable wireless transceiver device 22″ (FIG. 1) and any other devices 22 perform process 76, as well.

Process 76 begins with a task 78 to power “ON” first device 22′. Task 78 requires intervention by individual 24 (FIG. 1) to actuate power switch 36 (FIG. 2). Actuation of power switch 36 causes an initialization of processor 30 (FIG. 2).

A task 80 is performed in response to task 78. Task 80 causes processor 30 to place first device 22′ in a receive mode. In particular, processor 30 instructs transceiver/antenna 28 (FIG. 2) to “listen” for transmissions, i.e., receive, over frequency band 42 (FIG. 2).

A query task 82 is performed following task 80. Query task 82 determines whether transceiver/antenna 28 detects a load instruction 84 (see FIG. 2) over frequency band 42. Load instructions 84 are periodically transmitted from another device 22 (for example, second device 22″) and from fixed-location transmitter 26. When first device 22′ is located within a transmission range of second device 22″ or within a transmission range of fixed-location transmitter 26, and second device 22″ or transmitter 26 is transmitting, load instruction 84 may be detected by first device 22′.

When load instruction 84 is detected at query task 82, process 76 proceeds to a task 86 and subsequently to a task 88. At task 86, processor 30 enables receipt of load instruction 84. In conjunction with task 86, task 88 causes processor 30 to record load instruction 84 in memory element 32 (FIG. 2) of first device 22′. Individual 24 (FIG. 1) carrying first device 22′ may be unaware of the presence of second device 22″. In addition, individual 24 carrying first device 22′ may be unaware of the proximity of fixed-location transmitter 26 (FIG. 1). Furthermore, due to the periodic nature of transmissions from second device 22″ and transmitter 26, the specific time and location of receipt of load instruction 84 is unknown to individual 24 (FIG. 1).

In addition to, or alternatively, sensor 44 (FIG. 2) may periodically produce a sensor signal (not shown) responsive to a location of first device 22′ in environment 20 (FIG. 1). Accordingly, detection query task 82 may further entail detecting the sensor signal. When a sensor signal is detected, task 86 causes processor 30 to configure the sensor signal as load instruction 84, and task 88 causes processor 30 to record the sensor signal in memory element 32 as one of load instructions 84.

FIG. 6 shows an exemplary table 90, stored in memory element 32, of load instructions 84 received by first portable wireless transceiver device 22′ and one or more transmission load instructions 92 to be transmitted from device 22′. Load instructions 84 are stored as data records 91 in table 90. At a first iteration of tasks 82, 86, and 88, a first one of data records 91, i.e., a first data record 93, is recorded that contains a first load instruction 84′. Similarly, a subsequent iteration of tasks 82, 86, and 88 yields a second one of data records 91, i.e., a second data record 94, containing a second load instruction 84″. Thus, first device 22′ is capable of receiving a plurality of load instructions 84 periodically transmitted from a plurality of other devices 22, as well as from fixed-location transmitters, such as transmitter 26 (FIG. 1). Moreover, load instructions 84 are received at different instants in time when first device 22′ is positioned within a maximum transmission range of other devices 22 and fixed-location transmitters.

In a preferred embodiment, each load instruction 84 includes a pointer 96 associated with a particular game application. Pointer 96 is an address, or an instruction, which points to another part of a data structure. For example, pointer 96 may point to one of memory locations 68 (FIG. 4) or 74 to access one of scripts 66 (FIG. 4) associated with game application 64. Load instruction 84 advantageously includes pointer 96 so that load instruction 84 need not include the actual data, i.e., script 66, thus achieving savings in terms of the utilization of memory element 32, battery usage, and transmission overhead of load instruction 84.

Load instructions 84 recorded in table 90 need not all be associated with the same game, i.e., game application 64 (FIG. 4). Rather, different load instructions 84 may be associated with different game applications. For example, first load instruction 84′ includes pointer 96 associated with game “A”. For the sake of example, game “A” is game application 64. Second load instruction 84″ includes pointer 96 associated with game “B”, which is a different game application than game application 64. Device 22 does not have the capability to distinguish load instructions 64 for particular game applications. This distinction is performed by fixed-location platform 58 (FIG. 4), described below.

As discussed briefly above, a sensor signal produced by sensor 44 (FIG. 2) may be configured as one of load instructions 84. By way of example, pointer 96 of a third one of data records 91, i.e., a third data record 98, includes a sensor signal 100 configured as a third load instruction 84″′.

In addition to pointer 96, each load instruction 84 may optionally include an identification code 102 identifying a transmitter, i.e., either one of devices 22 or fixed-location transmitter 26 (FIG. 1) transmitting load instruction 84. Accordingly, first load instruction 84′ includes identification code 102, labeled “ID1”, and second load instruction 84″ includes identification code 102, labeled “ID2”. Third load instruction 84″′ includes identification code 102, labeled “ID0”, which identifies first device 22′ itself as the originator of load instruction 84″′.

Identification codes 102 may be utilized by fixed-location platform 58 (FIG. 4) to identify which devices 22 are coming into close proximity with one another so that individuals 24 can determine who their challengers are when playing game application 64 at fixed-location platform 58. This identification system encourages beneficial peer-to-peer social interactions because more satisfying game play occurs as players become acquainted with their challengers, and when devices 22 interact with many other such devices 22 to obtain as many load instructions 84 as possible.

One or more transmission load instructions 92, 92′, and 92″ stored in table 90 are periodically transmitted from first device 22′. Transmission load instructions 92 are uploaded to memory element 32 of first device 22′ from fixed-location platform 58 (FIG. 4) when first device 22′ is coupled with platform 58. Transmission load instructions 92 are configured to affect outcomes of one or more corresponding game applications, such as game application 64 (FIG. 4) executed on a second fixed-location platform (not shown) operating independently form fixed-location platform 58. The use of multiple transmission load instructions 92 is not a requirement of the present invention, but when used allows multiple game applications to be played in the same period of time.

Referring back to process 76 (FIG. 5), following recording task 88 or when task 82 determines that load instruction 84 is not detected, process 76 proceeds to a query task 104. At query task 104, processor 30 (FIG. 2) determines through internal clocking, if it is time for a transmit interval. In other words, processor 30 checks the passage of time to determine if it is time to transmit one of transmission load instructions 92 (FIG. 6) from first device 22′ (FIG. 1). In a preferred embodiment, devices 22 are configured to be in a receive mode a majority of time, but may be switched to a transmit mode periodically to transmit their own transmit transmission load instructions 92. For example transmission load instructions 92 may be transmitted from first device 22′ at five to ten second intervals.

When query task 104 determines that it is time to transmit, process 76 advances to a task 106. Task 106 causes processor 30 to place first device 22′ in a transmit mode. In particular, processor 30 instructs transceiver/antenna 28 (FIG. 2) to cease receive mode and to broadcast at least one transmission load instruction 92 over frequency band 42 (FIG. 2).

A task 108 is performed in cooperation with task 106. At task 108, one or more transmission load instructions 92 is transmitted from first device 22′. Following an interval of time during which a transmission load instruction 92 is broadcast, process 76 proceeds to a query task 110. Likewise, when query task 104 determines that it is not time to transmit transmission load instruction 62, process 76 proceeds to query task 110.

Query task 110 causes processor 30 to determine whether first device 22′ should continue to receive or should return to the sleep mode. There are several reasons for discontinuing the receive mode. For example, processor 30 may determine that insufficient power remains on battery 40 (FIG. 2) to sustain the receive mode. Alternatively, sensor 44 (FIG. 2) may be a motion detector, that causes processor 30 to continue first device 22′ in the receive mode in the presence of sufficient movement. In yet another exemplary scenario, first device 22′ may contain a timer that causes processor 30 to continue first device 22′ in the receive mode for a predetermined interval of time.

When query task 110 determines that first device 22′ should continue to “listen” for load instructions 84 (FIG. 6), program control loops back to task 80 so that first device 22′ remains in or is placed back into the receive mode. However, when query task 110 determines that first device 22′ should not be in the receive mode process 76 proceeds to a query task 112.

Query task 112 determines whether first device 22′ should be placed in a sleep mode. The sleep, or stand-by, mode causes processor 30 to cease the execution of the instruction set that performs process 76 for a period of time to advantageously conserve battery power. When query task 112 determines that first device 22′ should be placed in sleep mode, process 76 proceeds to a task 114.

At task 114, first device 22′ is placed in sleep mode and the execution of the instruction set that performs process 76 is discontinued.

Following task 114, a query task 116 is performed. At query task 116, processor 30 determines if first device 22′ should “wake” from the sleep mode initiated at task 114. First device 22′ can be removed from the stand-by mode in response to motion, light, time, and so forth. When query task 116 determines that first device 22′ should be removed from the sleep mode, process 76 loops back to task 80 to return first device 22′ to the receive mode in order to continue “listening” for load instructions 84.

However, when processor 30 determines that first device 22′ should continue the sleep mode, process 76 loops back to task 114 to maintain the sleep mode and to later perform query task 116.

Referring back to query tasks 110 and 112, when query task 110 determines that the receive mode is to be discontinued, and when query task 112 determines that first device 22′ is not to be placed in sleep mode, process 76 proceeds to a task 118 at which time power is removed from first device 22′ with or without the intervention of individual 24 (FIG. 1). Following task 118, process 76 exits.

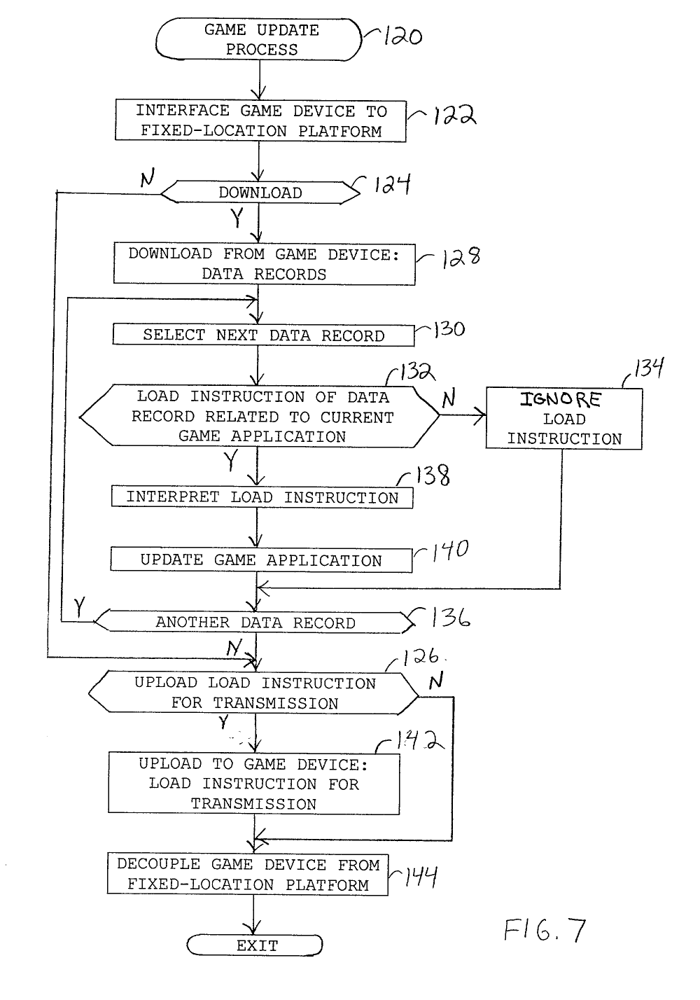

FIG. 7 shows a flowchart of a game update process 120 performed at fixed-location platform 58 (FIG. 4). When individual 24 (FIG. 1) returns home following work, school, or other daily activities, process 120 may be performed to download load instructions 84 (FIG. 6), if any, from first portable wireless device 22′ to fixed-location platform 58 (FIG. 4). In addition, process 120 may be performed to upload transmission load instructions 92 (FIG. 6) from fixed-location platform 58 to first portable wireless device 22′. Process 120 is described in connection with first device 22′ for clarity. However, it should be readily apparent that process 120 is performed for second portable wireless transceiver device 22″ (FIG. 1) and any other devices 22 in cooperation with their respective fixed-location platform 58.

Process 120 begins with a task 122. At task 122, first device 22′ is interfaced with fixed-location platform 58. This can be performed by connecting cable 60 (FIG. 4) between USB interface 34 on first device 22′ and USB port 62 on fixed-location platform 58. Alternatively, USB interface 34 may directly connect to USB port 62 without the need for cable 60.

In addition, task 122 causes a program executable from fixed-location platform 58 to be invoked in order to enable the download of the contents of table 90 (FIG. 6) from memory element 32 (FIG. 6) of first device 22′ and/or to enable the upload of transmission load instructions 92 from fixed-location platform to memory element 32. This program may be a segment of game application 64 (FIG. 4). Alternatively, this program may be a general file transfer program. In either instance, the program performs the download and upload activities of process 120. Following task 122, a query task 124 is performed.

Query task 124 determines if a download activity is to be performed. A download activity may not be performed if individual 24 (FIG. 1) only desires to upload transmission load instructions 92 (FIG. 6) to first device 22′. Additionally, a download activity may not be performed if there are no data records 91 currently stored in memory element 32. When query task 124 determines that a download activity is not to be performed, process 120 proceeds to a query task 126, discussed below. Alternatively, when data records 91 of table 90 are to be downloaded to platform 58, process 120 proceeds to a task 128.

At task 128, platform 58, through the execution of a program, for example, game application 64 (FIG. 4) or a general file transfer program, downloads data records 91 containing load instructions 84 from memory element 32 of first portable wireless transceiver device 22′ to fixed-location platform 58.

Following download task 128, a task 130 is performed. Task 130 causes platform 58 to select a next one of data records 91. Of course, it should be understood that at a first iteration of task 130, the “next” one of data records 91 is a “first” one to be selected. By way of example, at a first iteration of task 130, first data record 93 (FIG. 6) is selected.

A query task 132 is performed in response to task 130. Query task 132 determines if load instruction 84 of the selected one of data records 91 is associated with the current game application, i.e., game application 64 (FIG. 4). When query task 132 determines that load instruction 84 of the selected one of data records 91 is not associated with game application 64, process 120 proceeds to a task 134.

At task 134, the selected one of data records 91 containing the unrelated load instruction 84 is ignored. Following task 134, process 120 advances to a query task 136.

However, when query task 132 determines that load instruction 84 of the selected one of data records 91 is associated with game application 64, process 120 proceeds to a task 138. For example, first data record 93 containing first load instruction 84′ includes pointer 96 associated with game “A”, i.e. game application 64. As such, following the selection of first data record 93 at task 130 and the determination of first load instruction 84′ (FIG. 6) as being associated with game application 64, task 138 is performed. Accordingly, query task 132 distinguishes ones of load instructions 84 as being associated with game application 64 from those of load instructions 84 that are not associated with game application 64.

At task 138, first load instruction 84′ is interpreted. In other words, platform 58 evaluates first load instruction 84′ to determine that it includes pointer 96 and identification code 102 (FIG. 6). Through the execution of task 138, platform 58 utilizes pointer 96 to point to one of memory locations 68 (FIG. 4) on fixed-location platform 58 or one of memory locations 74 (FIG. 4) on web/game server 72 (FIG. 4) to access one of scripts 66 (FIG. 4) associated with game application 64. In addition, through the execution of task 138, identification code 102 is recorded at fixed-location platform 58 in association with game application 64 to establish a list of competitors, i.e., other individuals 24 (FIG. 1) who have portable wireless transceiver devices 22 from whom load instructions 84 were received.

Following task 138, a task 140 is performed. At task 140, game application 64 is updated through the execution of the one of scripts 66 accessed through pointer 96 at task 138. The execution of script 66 affects an outcome of game application 64 by modifying the game experience of game application 64 as a function of the data exchanged. For example, characters can be collected, copied, stored, transferred, or morphed. Virtual characters, virtual animals, virtual cards, and even virtual coupons can be collected, shared, traded, and tracked via load instructions 84.

In an exemplary scenario, “playing” game application 64 may entail the construction of an environment containing people, neighborhoods, modes of transportation, and so forth, and observing the interaction of the entities within the environment. Through the execution of one or more scripts 66, additional and unexpected characters may be incorporated into the environment created when playing game application 64. These new characters can then interact with the pre-existing entities in the environment.

In another exemplary scenario, “playing” game application 64 may entail battles with enemies in order to reach a final destination, such as to uncover a treasure. Through the execution of one or more scripts 66, additional and unexpected characters, weapons, or obstacles may be incorporated into the virtual environment of game application 64. These new entities can impede or aid the player in uncovering the treasure. Thus, the execution of scripts 66 pointed to through the receipt of load instructions 84 adds a random element of game play that enhances the overall experience of game application 64.

In other scenarios, at task 140, game application 64 is updated through the interpretation of sensor signal 100 (FIG. 6) detected in one of load instructions 84. Sensor signal 100 may be utilized by game application 64 to affect the virtual environment of game application 64. For example, by utilizing the sensed temperature, humidity, light, motion, audio level, location signals, and so forth, produced by sensor 44 (FIG. 2), the virtual environment of game application 64 may be altered to more closely match the actual environment through which the plater travels in the course of his or her daily activities.

Referring back to process 120 (FIG. 6) following updating task 140, program control proceeds to query task 136. Similarly, following task 134 in which an unrelated load instruction 84 was discarded, query task 136 is performed. Query task 136 determines whether there is another one of data records 91 that was downloaded from first device 22′. When there is another one of data records 91, process 120 loops back to task 130 to select the next one of data records 91 and update game application 64 when associated with game application 64. As such, each one of load instructions downloaded from first device 22′ is evaluated. When query task 136 determines that there are no other data records 91, process 120 proceeds to query task 126. Similarly, as mentioned previously, when query task 124 determines that a download activity is not to be performed, process 120 proceeds to query task 126.

Query task 126 determines whether transmission load instructions 92 are to be uploaded from fixed-location platform 58 to first portable wireless transceiver device 22′. When transmission load instructions 92 are to be uploaded, process 120 proceeds to a task 142.

At task 142, transmission load instructions 92 (FIG. 6) are uploaded from fixed-location platform 58 to memory element 32 of first device 22′. Transmission load instructions 92 are subsequently periodically transmitted from first device 22′ when one of individuals 24 (FIG. 1) carrying first device 22′ is carrying out their daily activities.

Following task 142, or when query task 126 determines that transmission load instruction is not to be uploaded from fixed-location platform 58 to first device 22′, a task 144 is performed. Task 144 causes first device 22′ to be decoupled from fixed-location platform. Thereafter, process 120 exits. Process 120 is described with device 22′ being interfaced with platform 58 as a first activity, task 122, and as being decoupled from platform as a last activity, task 144, for simplicity of illustration. However, it should be understood that following download task 128, device 22′ need not interface platform 58 to perform the subsequent tasks 130, 132, 134, 138, 140, and 136 in which the downloaded load instructions 84 are evaluated.

In summary, the present invention teaches of a portable, wireless game device and method that extends entertainment or game activity beyond a conventional fixed-location platform. In particular, through the transmission and reception of gaming information between game devices, a user can influence a game application executable from the fixed-location platform while being separated from the fixed-location platform. In addition, game play of game application is enhanced through random interactions of devices without the user's attention or knowledge. The exchange of game data and the recordation of identification codes of other devices promote social interaction between game players.

Although the preferred embodiments of the invention have been illustrated and described in detail, it will be readily apparent to those skilled in the art that various modifications may be made therein without departing from the spirit of the invention or from the scope of the appended claims. That is, many other game scenarios and many other types of data exchanges between devices can occur. For example, the transceiver devices may collect electronic “product coupons” from the fixed-location transmitters that can be later downloaded from the devices and utilized. In addition, those skilled in the art will appreciate that the present invention will accommodate a wide variation in the specific tasks and the specific task ordering used to accomplish the processes described herein.

What is claimed is:

1. A method for influencing an application executable from a fixed-location platform comprising:
receiving a load instruction at a portable wireless transceiver;
recording said load instruction in a memory element of said portable wireless transceiver;
interfacing said portable wireless transceiver with said fixed-location platform;
downloading said load instruction from said portable wireless transceiver to said fixed-location platform; and
updating, at said fixed-location platform, said application in response to said load instruction to affect an outcome of said application.

2. A method as claimed in claim 1 wherein said receiving operation occurs unknown to a user of said portable wireless transceiver.

3. A method as claimed in claim 1 wherein:
said method further comprises periodically transmitting said load instruction from a wireless transmitter; and
said receiving operation comprises detecting said load instruction at said portable wireless transceiver when said portable wireless transceiver is positioned within a maximum transmission range of said wireless transmitter.

4. A method as claimed in claim 3 further comprising utilizing a license free frequency band to periodically transmit said load instruction from said wireless transmitter.

5. A method as claimed in claim 3 wherein said portable wireless transceiver is a first portable wireless transceiver and said wireless transmitter is a second portable wireless transceiver.

6. A method as claimed in claim 3 wherein said wireless transmitter is a fixed-location transmitter.

7. A method as claimed in claim 1 wherein said portable wireless transceiver includes a sensor, and said receiving operation comprises:
producing a sensor signal at said sensor responsive to a location of said transceiver; and
configuring, prior to said receiving operation, said sensor signal as said load instruction.

8. A method as claimed in claim 1 further comprising:
determining, at said fixed-location platform, that said load instruction includes an identification code identifying a second portable wireless transceiver transmitting said load instruction; and
recording, at said fixed-location platform, said identification code of said second portable wireless transceiver.

9. A method as claimed in claim 1 further comprising:
determining, at said fixed-location platform, that said load instruction includes a pointer to a memory location associated with said application;
executing a script stored in said memory location in response to said determining operation; and
interpreting data within said script to affect said outcome of said application.

10. A method as claimed in claim 9 wherein said memory location is at said fixed-location platform, said script is provided with said application, and said updating operation comprises enabling execution of said script in response to said downloaded load instruction.

11. A method as claimed in claim 9 wherein said memory location is at a remote server accessible via the Internet, and said updating operation comprises enabling execution of said script in response to said downloaded load instruction.

12. A method as claimed in claim 1 wherein said load instruction is one of a plurality of load instructions, and said method further comprises:
receiving, at said portable wireless transceiver, each of said plurality of load instructions at different instants in time;
recording said each load instruction in said memory element of said portable wireless transceiver;
downloading said each load instruction from said portable wireless transceiver to said fixed-location platform;
distinguishing said one of said plurality of load instructions as being associated with said application; and
performing said updating operation only for said one of said plurality of load instructions.

13. A method as claimed in claim 1 wherein said fixed-location platform is a first fixed-location platform, and said method further comprises:
uploading a second load instruction from said fixed-location platform to said portable wireless transceiver, said second load instruction being configured to affect an outcome of said application running on a second fixed-location platform, said second fixed-location platform operating independently from said first fixed-location platform; and
periodically transmitting from said portable wireless transceiver said second load instruction.

14. A portable wireless device for influencing an application executable from a fixed-location platform comprising:
a transceiver for detecting load instructions transmitted from wireless transmitters at different instants in time and positioned at different locations;
a processor in communication with said transceiver for receiving said load instructions;
a memory element in communication with said processor, said processor recording each of said load instructions in said memory element; and
an interface in communication with said processor and configured for coupling with said fixed-location platform so that said load instructions may be downloaded to said fixed-location platform, wherein at least one of said load instructions is operable to affect an outcome of said application.

15. A portable wireless device as claimed in claim 14 further comprising a sensor in communication with said processor and configured to produce a sensor signal responsive to a location of said wireless portable device, said processor recording said sensor signal in said memory as one of said load instructions.

16. A portable wireless device as claimed in claim 14 wherein said load instruction includes an identification code identifying a second portable wireless device transmitting said load instruction.

17. A portable wireless device as claimed in claim 14 wherein said load instruction includes a memory location associated with said game application, said memory location having a script stored therein for affecting said outcome of said game.

18. A portable wireless device as claimed in claim 14 wherein a second load instruction is uploaded from said fixed-location platform to said portable wireless device when said portable wireless device is coupled with said fixed-location platform via said interface, said second load instruction being configured to affect an outcome of said application executable from a second fixed-location platform, and said transceiver is configured to periodically transmit said second load instruction.

19. A method for influencing a game application executable from a fixed-location platform comprising:
periodically transmitting load instructions from a plurality of wireless game transceivers;
receiving, at one of said wireless game transceivers, said load instructions at different instants in time when said one wireless game transceiver is positioned within a maximum transmission range of others of said wireless game transceivers, said receiving operation occurring unknown to a user of said one wireless game transceiver;
recording said load instructions in a memory element of said one wireless game transceiver;
interfacing said one wireless game transceiver with said fixed-location platform;
downloading said load instructions from said one wireless game transceiver to said fixed-location platform;
distinguishing one of said load instructions as being associated with said game application; and
updating, at said fixed-location platform, said game application in response to said one load instruction to affect an outcome of said game application.

20. A method as claimed in claim 19 further comprising:
uploading a second load instruction from said fixed-location platform to said one wireless game transceiver, said second load instruction being configured to affect an outcome of said game application running on a second fixed-location platform, said second fixed-location platform operating independently from said first fixed-location platform; and
periodically transmitting said second load instruction from said one wireless game transceiver for receipt by others of said wireless game transceivers.
